(19) United States
(12) Patent Application Publication
(10) Pub. No.: US 2026/0338713 A1
(43) Pub. Date: Oct. 29, 2026

(54) Linear Motion Stage in X-Ray Devices

(71) Applicant: Lumafield, Inc., Cambridge, MA (US)

(72) Inventors: Sahil Rajesh SHAH, Cambridge, MA (US); Caroline Anne JORDAN, Arlington, MA (US); Melody LEI, Staten Island, NY (US)

(21) Appl. No.: 19/237,580

(22) Filed: Jun. 13, 2025

Related U.S. Application Data
(60) Provisional application No. 63/665,701, filed on Jun. 28, 2024.

(51) Int. Cl. G01N 23/046

(52) U.S. Cl. CPC G01N 23/046; G01N 2223/1016; G01N 2223/3306; G01N 2223/3307; G01N 2223/3308; G01N 2223/419

(57) ABSTRACT

Provided herein are methods, apparatuses, computer program products, and systems for a motion system in X-ray devices. One device can include an X-ray source configured to emit X-rays; a detector configured to obtain X-ray scan data of an object; and a motion system including: a linear motion stage including a main rail attached to one side of a base plate and a counter rail attached to an opposite side of the base plate, wherein the counter rail is matched with the main rail in both a deviation from straightness using a straightness characterization and a coefficient of thermal expansion, and a carriage attached to the main rail of the linear motion stage, wherein the carriage is arranged to hold the object; wherein the motion system is configured to move the object in relation to the X-ray source by moving the carriage along the main rail of the linear motion stage.

### CROSS-REFERENCE TO RELATED APPLICATIONS

This patent application claims priority to and the benefit of U.S. Provisional Patent Application No. 63/665,701, filed on Jun. 28, 2024, which is incorporated herein by reference in its entirety.

### BACKGROUND

This specification relates to X-ray devices, such as computed tomography (CT) devices.

X-ray devices can be used to detect defect(s) in and/or damage to an object (e.g., a manufactured part) without disassembling the object. For example, an X-ray CT scanner can be used by manufacturers to determine the quality of the products which they produce. X-ray devices are particularly useful to give manufacturers the ability to inspect certain parts of their products in a non-invasive, non-destructive fashion. Given this, X-ray devices are becoming more popular in production manufacturing settings where quality control is of high importance.

### SUMMARY

Some X-ray devices have a motion system and objects are positioned between an X-ray source and a detector by the motion system. However, some motion systems can be inaccurate in positioning of the objects. Inaccurate positioning of an object with respect to the X-ray source and the detector produces errors in a reconstruction image generated from scan data of the object. In some implementations, inaccurate positioning of an object in an industrial CT scanner can produce CT reconstruction errors, including improper geometric scaling that sometimes results in the reconstructed object being larger or smaller than that of the physical object.

One source of object positioning inaccuracies is linear motion straightness errors along a magnification direction of an X-ray device. For an ideal system with no linear motion straightness errors, an object travels parallel to a linear motion stage included in the motion system so that object position matches a target position. However, straightness errors of the linear motion stage can cause the object position to deviate from the target position. These object positioning errors are exacerbated when an object is held further away from the linear motion stage, for example, at the end of a cantilever that holds the object.

In some X-ray devices, the linear motion stage includes a rail attached to a base plate and one or more carriages attached to the rail and arranged to hold the object. The motion system is configured to move the object by moving the carriage along the rail. There are two main causes for the straightness errors of the linear motion stage. First, shape errors in the rail and/or the base plate can result in straightness errors for the linear motion stage. Second, differences in the coefficient of thermal expansion (CTE) between the material(s) of the rail and the material(s) of the base plate can cause the linear motion stage to curve with temperature changes, introducing or adding to the straightness errors of the linear motion stage.

To achieve straight linear motion, some X-ray devices mount the main rail to a base plate that is required to be both extremely straight and has a high stiffness. For example, the stiffness for the base plate can be required to be twice as or more than the stiffness for the main rail. Satisfying both requirements can result in increased manufacturing costs and/or heavy assemblies that are difficult to handle. To decrease straightness errors of the linear motion stage due to temperature variation, some X-ray devices can apply active temperature control of the temperature within the X-ray devices, or can use materials with low CTE (e.g., a nickel-iron alloy), either or both of which can be very expensive.

This specification describes technologies relating to improving accuracies of a motion system in industrial X-ray devices. In particular, by attaching a counter rail of similar shape to the main rail to the other side of the base plate of the linear motion stage, the main rail and the counter rail can counteract each other to improve the overall straightness of the linear motion stage. Furthermore, using a counter rail of a similar material as the main rail (e.g., having similar CTEs) can decrease the degree to which the overall straightness of the linear motion stage is affected by temperature change.

Particular embodiments of the subject matter described in this specification can be implemented to realize one or more of the following advantages. Rather than using expensive manufacturing and material requirements of stiffness and straightness for the base plate, by adding a counter rail that matches the main rail in shape and in deviation from straightness, the X-ray devices described in this specification can relax the manufacturing and material requirements of stiffness and straightness for the base plates and can use mass produced off-the-shelf rails to meet the target straightness of the linear motion stage assembly, and the linear motion stage is mostly insensitive to base plate manufacturing errors. Rather than using a heavy base plate to meet the straightness and stiffness requirements, adding a second rail to the linear motion stage does not significantly add to the total mass of the linear motion stage assembly. Instead of relying on expensive active temperature control or using expensive low CTE materials, the X-ray devices described in this specification can have improved thermal stability by leveraging the symmetric geometry of the main rail and the counter rail of similar shape to the main rail attached to two opposite sides of the base plate, reducing the cost of the X-ray devices along with the straightness errors in the linear motion stage.

Some methods use autocollimators to characterize the straightness profile of a surface. However, autocollimators are sensitive systems that are cumbersome to use in a manufacturing setting. Based on knowledge that the errors in the straightness profiles of rails mostly arise in the form of a parabolic shape for the rails, in some implementations, the systems and techniques described in this specification can use a repeatable single dial-indicator measurement process taken at the center of a rail. The dial-indicator measurement process is much simpler and faster than using autocollimators and does not require a complex set up procedure, significantly simplifying the data acquisition process for measuring and pairing the main rails and the counter rails for the linear motion stage assembly for the motion system of the X-ray devices.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1A shows a front view of an example of an X-ray device.

FIG. 1B shows a top-down view of an example of an X-ray device having linear motion straightness errors.

FIG. 1C shows a top-down view of an example of an X-ray device that includes a counter rail.

FIG. 1D shows a side view of an example of an X-ray device that includes a counter rail.

FIG. 2 is a flowchart showing an example of a process to construct a linear motion stage.

FIG. 3 shows examples of straightness profiles for a main rail, a counter rail, and a linear motion stage assembly.

FIG. 4 shows examples of angular deviations for a main rail, a counter rail, and a linear motion stage assembly.

FIG. 5 shows examples of a neutral axis of a linear motion stage without and with a counter rail added to the backside of the base plate.

FIG. 6 shows examples of thermal stability of a linear motion stage without and with a counter rail added to the backside of the base plate.

FIG. 7A shows an example of a rail straightness measuring device.

FIG. 7B shows an example of a rail straightness measuring device performing a calibration using a calibration bar.

FIG. 7C shows an example of a rail straightness measuring device performing a straightness measurement of a rail.

Like reference numbers and designations in the various drawings indicate like elements.

### DETAILED DESCRIPTION

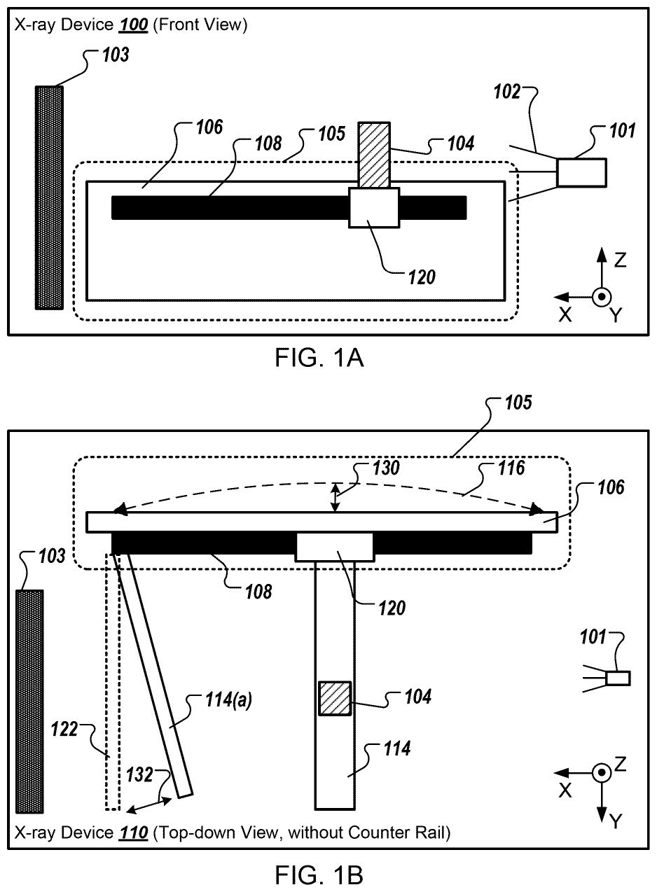

FIG. 1A shows a front view of an example of an X-ray device 100. In some implementations, the X-ray device 100 can be a computed tomography (CT) scanner. The X-ray device 100 includes an X-ray source 101 configured to emit X-rays 102. In some implementations, the X-ray source 101 can emit an X-ray beam, which may be a pencil beam, fan beam, cone beam, etc. The X-ray device 100 includes a detector 103 configured to obtain X-ray scan data of an object 104 (e.g., a part or a target object) that has been placed in the X-ray device 100. The X-ray scan data can include projections of the X-rays after interaction with the object 104.

The X-ray device 100 includes a motion system configured to move, reposition, maneuver, or otherwise manipulate the object 104 relative to the X-ray source 101. The motion system includes a linear motion stage 105. The linear motion stage 105 includes a main rail 108 attached to one side of a base plate 106. For example, the main rail 108 and the base plate 106 can be bolted, screwed, or glued together.

The linear motion stage 105 includes a carriage 120 attached to the main rail 108 of the linear motion stage 105, and the carriage 120 is arranged to hold the object 104. The motion system is configured to move the object 104 in relation to the X-ray source 101 by moving the carriage 120 along the main rail 108 of the linear motion stage 105. For example, the motion system of the X-ray device 100 can move the object 104 along the magnification direction, e.g., along the X-axis in FIG. 1A.

In some X-ray devices, the motion system may have inaccurate positioning of an object with respect to the X-ray source and the detector. One source of object positioning inaccuracies is linear motion straightness errors along the magnification direction (e.g., the X-axis direction in the coordinate system in FIG. 1A) of an X-ray device. For an ideal system with no linear motion straightness errors, an object travels parallel to a perfectly straight linear motion stage included in the motion system so that object position matches a target position. However, straightness errors of the linear motion stage can cause the object position to deviate from the target position. The inaccurate positioning produces errors in the X-ray scan data of the object and the reconstruction image generated from the scan data. For example, inaccurate positioning of an object in an industrial CT scanner can result in a source to object distance (SOD) that is different from a desired SOD, and thus can cause improper geometric scaling (e.g., an incorrect magnification factor calculated based on the SOD) that produces CT reconstruction errors.

FIG. 1B shows a top-down view of an example of an X-ray device 110 having linear motion straightness errors. Shape errors in the main rail 108, the base plate 106, or both, can result in straightness errors for the linear motion stage 105. For example, the straightness profile 116 (enlarged to show details) of the linear motion stage 105 can have a parabolic shape. Due to the straightness errors in the linear motion stage 105, the likely motion path of the carriage 120 attached to the main rail 108 of the linear motion stage 105 is not straight and can have a shape similar to the straightness profile 116 of the linear motion stage 105. Therefore, the object 104 being moved along with the carriage 120 can have inaccurate positions.

In some implementations, as shown in FIG. 1B, the motion system can include a cantilever 114 attached to one or more carriages 120, and the one or more carriages 120 can be arranged to hold the object 104 via the cantilever 114. The object can be held at a desired location on the cantilever 114, either close to the linear motion stage 105 or further away from the linear motion stage 105. The straightness errors of the linear motion stage 105 can produce angular deviations 132 of the cantilever 114. When the carriage 120 that the cantilever 114 is attached to moves along the main rail 108, the cantilever 114 will not always be perpendicular to the X-axis if the main rail 108 (attached to the base plate 106) is not perfectly straight along that X-axis. For example, when the carriage 120 moves to the leftmost end of the main rail 108, the actual position 114(a) of the cantilever is different from the target position 122 of the cantilever. There is an angular deviation 132 between the actual position 114(a) of the cantilever and the target position 122 of the cantilever. This angular deviation 132 results in Abbe errors that cause the position of the object 104 to deviate from a target position. The Abbe errors of the object 104 are exacerbated when the object 104 is held further away from the linear motion stage 105, for example at the end of the cantilever 114 away from the main rail 108.

FIG. 1C shows a top-down view of an example of an X-ray device 140 that includes a counter rail 124. FIG. 1D shows a side view of an example of an X-ray device 140 (the same device 140 as in FIG. 1C) that includes the counter rail 124. The example X-ray device 140 includes the same components as described for the example X-ray device 100 in connection with FIG. 1A. In addition, the example X-ray device 140 includes the counter rail 124.

The main rail 108 is attached to one side 142 of the base plate 106 and the counter rail is attached to the opposite side 144 of the base plate 106. For example, the counter rail 124 and the base plate 106 can be bolted, screwed, or glued together. The main rail 108 and the counter rail 124 occupy about the same region of the base plate 106 from the two opposite sides. In some implementations, the main rail and the counter rail can have the same shape and the shape material, and the main rail and the counter rail can occupy the same region of the base plate from the two opposite sides. In some implementations, the main rail and the counter rail can have matched shapes that are similar to each other, and the main rail and the counter rail can occupy about the same region of the base plate from the two opposite sides. For example, when placed side-by-side, the profiles for the main rail and the counter rail do not deviate beyond 25 μm to 200 μm of each other.

The counter rail 124 is matched with the main rail 108 in both a deviation from straightness using a straightness characterization and a coefficient of thermal expansion (CTE). The matched counter rail 124 counteracts the straightness errors of the linear motion stage 105 (e.g., the straightness errors of the base plate, the main rail, or both) and makes the straightness of the base plate less influential in the assembly, resulting in straighter linear motion of the object 104 when the object is moved by the linear motion stage 105.

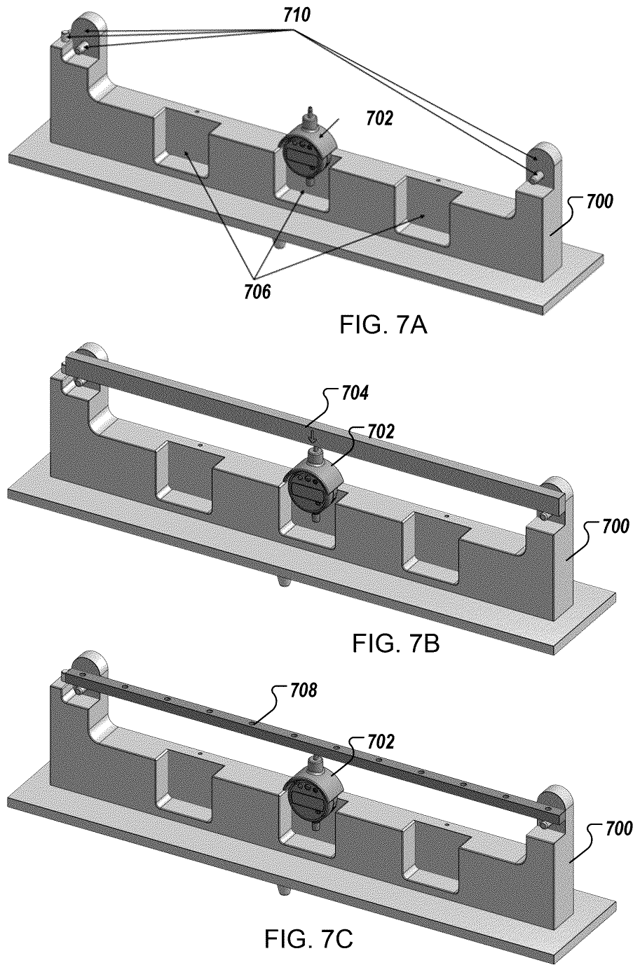

In some implementations, because the errors in the straightness profiles of rails mostly arise in the form of a parabolic shape for the rails, the straightness characterization of a rail can include a single measurement at the mid-point of the rail. For example, in FIG. 1B, the straightness error for main rail 108 can be the single measurement 130 at the mid-point of the main rail 108. In some implementations, the straightness characterization can be based on measurements at two or more locations on a rail. For example, the straightness characterization can be an average of measurements at three locations on the rail. In some implementations, an autocollimator can be used to characterize the straightness of a rail. Other straightness characterization methods are possible. In some implementations, the straightness characterization of a rail can include taking measurements using a dial indicator traversing the length of the rail. In some implementations, 3D photogrammetry can be used to characterize the straightness of a rail. More details for a rail straightness measuring device performing a straightness measurement of a rail are described in connection with FIGS. 7A-7C.

In some implementations, the contribution of the base plate to the overall stiffness of the linear motion stage along the Y-axis can be required to be much less (e.g., less than 20%, 15%, or 10%) than the contribution of the rails. In some implementations, to achieve the contributions to the overall stiffness stated above, the product of the E (Young's Modulus) for the material of the base plate and the I (the second area moment of inertia about the assembly's neutral axis) for the base plate can be required to be at least 5 to 10 times less than the product of the E for the material(s) of the rails and the I of the rails. In some implementations, to achieve the contributions to the overall stiffness stated above, the material for the main rail 108 can be required to have a higher stiffness (e.g., larger Young's Modulus) than that of a material for the base plate 106. For example, the stiffness of steel 4130 used for the main rail can be 205 GPa (gigapascals), which is much higher than the stiffness of aluminum 6061 with 68.9 GPa used for the base plate. In some implementations, to achieve the contributions to the overall stiffness stated above, the thickness of the base plate along the Y-axis can be required to be equal to or less than the thickness of the main rail and the counter rail. For example, referring to FIG. 1D, the thickness 136 of the base plate 106 along the Y-axis can be required to be equal to or less than the thickness 134 of the main rail 108, and the counter rail 124 has the same thickness as the main rail 108. In some implementations, to achieve the contributions to the overall stiffness stated above, the material for the main rail can be required to have a higher stiffness than that of a material for the base plate, and the thickness of the base plate along the Y-axis can be required to be equal to or less than the thickness of the main rail (e.g., and the counter rail).

The counter rail 124 is matched with the main rail 108 in their material. The material for the counter rail 124 can be the same as the material for the main rail 108, or can be a material having similar stiffness as the material for the main rail 108. For example, the main rail 108 and the counter rail 124 can use steel or stainless steel, and the base plate 106 can use aluminum, magnesium, or cast iron. As another example, the main rail 108 and the counter rail 124 can use aluminum, and the base plate 106 can use plastic. Therefore, by adding the counter rail 124 to the back of the base plate 106, the X-ray device 140 can relax the manufacturing and material requirements of stiffness and straightness for the base plate and can use mass produced off-the-shelf rails for the main rail and the counter rail to meet the target straightness of the linear motion stage 105, and the linear motion stage is mostly insensitive to base plate manufacturing errors.

The counter rail 124 is matched with the main rail 108 in a deviation from straightness using one of the straightness characterization methods described herein. In some implementations, the counter rail 124 can have the same straightness profile as or a similar straightness profile to the main rail 108. For example, both the main rail 108 and the counter rail 124 can have a parabolic straightness profile with the same or similar heights. In some implementations, using one of the straightness characterization methods described herein, the counter rail 124 can have the same straightness error as or a similar straightness error to the main rail 108. In some implementations, using one of the straightness characterization methods described herein, a straightness error of the linear motion stage 105 can be reduced to be less than a threshold as a result of attaching the counter rail 124 to the base plate 106. For example, the threshold can be a value between 25 μm (micrometer) and 300 μm.

In some implementations, using one of the straightness characterization methods described herein, the main rail 108 can have a first straightness error before being attached to the base plate 106, and the counter rail 124 can have a second straightness error before being attached to the base plate 106. The counter rail 124 is matched with the main rail 108 in a deviation from straightness when an absolute value of a difference between the first straightness error and the second straightness error is less than a threshold. For example, the threshold can be 20 μm, 25 μm, or 50 μm. In some implementations, if the desired straightness error for the linear motion stage is a first threshold, the absolute value of a difference between the straightness error of the main rail and the straightness error of the counter rail can be required to be less than two times the first threshold. For example, if the desired straightness error for the linear motion stage is 50 μm, the difference between the straightness errors of the main rail and the counter rail should be less than 100 μm.

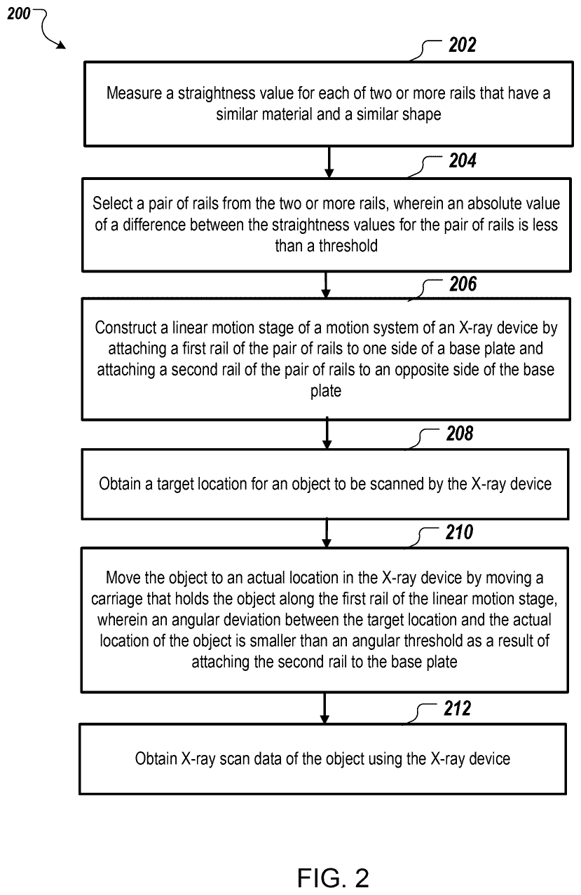

FIG. 3 shows examples of a top-down view of straightness profiles (enlarged to show details) for a main rail, a counter rail, and a linear motion stage assembly. The straightness profile for the main rail is the U-shape (parabolic) curve 304. The straightness profile for the counter rail is the U-shape (parabolic) curve 302. The main rail can have a straightness error of y2=153 μm. The counter rail can have a straightness error of y1=173 μm. The main rail and the counter rail are paired based on having similar straightness errors. For example, an absolute value of the difference between the straightness error of the main rail and the straightness error of the counter rail is |y2−y1|=|153−173|=20 μm, which is less than a threshold of 25 μm. When the main rail and the counter rail are attached (e.g., bolted) to two opposite sides of the base plate, the straightness errors of the main rail and the counter rail can negate each other. The straightness profile for the linear motion stage is 306, which is an overall straighter assembly than would have been achieved by attaching only the main rail to the base plate.

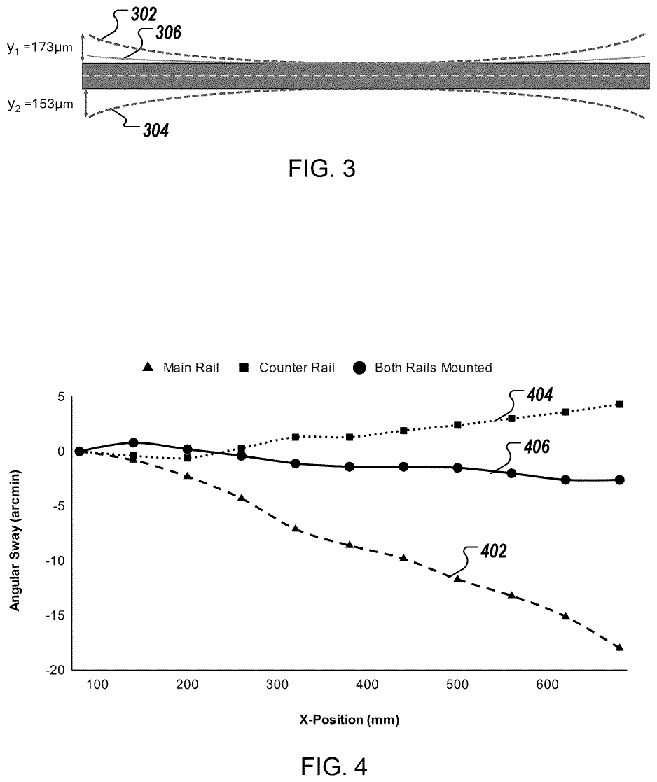

FIG. 4 shows examples of angular deviations for a main rail, a counter rail, and a linear motion stage assembly. FIG. 4 shows a reduction of angular deviation (e.g., angular sway) by adding the counter rail to the back of the base plate. The angular deviation is measured using an autocollimator along various X positions along the X-axis in FIG. 1A. With only the main rail attached to the base plate, the angular deviation of the linear motion stage is the curve 402, which has a maximum angular deviation of −18 arcminutes. Arcminute is a unit for angular measurement and one arcminute equals 0.00029 of a radian. With only the counter rail attached to the base plate, the angular deviation of the linear motion stage is the curve 404, which has a maximum angular deviation of 4.3 arcminutes. With both the main rail and the counter rail attached to the base plate, the angular deviation of the linear motion stage is the curve 406, which has a maximum angular deviation of −2.6 arcminutes. The source to distance error can be reduced from 1.31 mm to 0.19 mm for an object placed at the far end of a cantilever with a length of 250 mm. Compared to having only the main rail attached to the base plate, adding the counter rail to the base plate results in more than six times reduction in angular deviation of the linear motion stage.

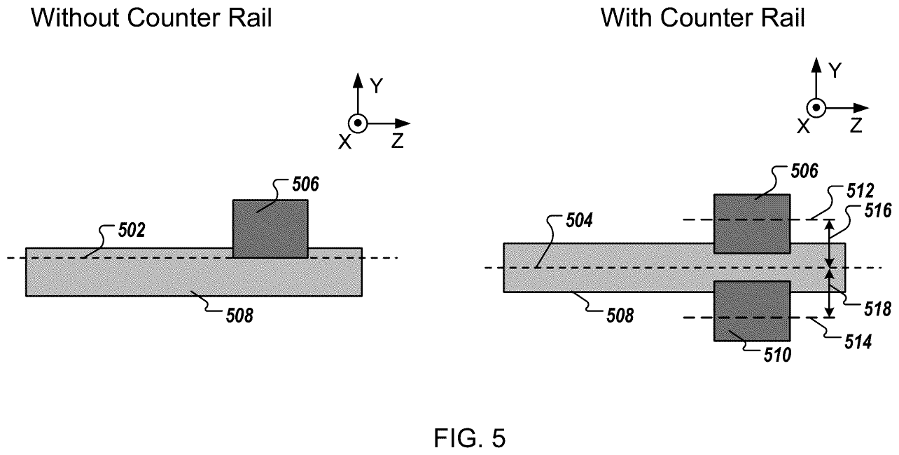

FIG. 5 shows examples of a neutral axis of a linear motion stage without and with a counter rail added to the backside of the base plate. FIG. 5 is a side view of the linear motion stage. Without the counter rail (FIG. 5 left side), the neutral axis 502 can be away from a plane of symmetry of the base plate. For example, if a linear motion stage includes an aluminum base plate 508 and a steel main rail 506, the neutral axis 502 can be close to the interface of the base plate 508 and the main rail 506. As a result, both the base plate 508 and the main rail 506 have similar influence over the net shape that the linear motion stage takes. For example, the main rail can have 51% influence over the net shape of the linear motion stage and the base plate can have 49% influence over the net shape of the linear motion stage.

When a counter rail 510 of the same or similar cross-sectional geometry and of a matched material (with greater stiffness than the base plate) to the main rail is added (FIG. 5 right), the neutral axis 504 shifts toward the plane of symmetry. Thus, the net straightness of the linear motion stage is largely a function of the counteracting straightness profiles of the main rail and the counter rail. That is, the straightness of the linear motion stage can largely depend on the stiffness of the main rail and counter rail, and can depend less on the stiffness of the base plate. The contribution of the base plate to the overall stiffness of the linear motion stage assembly) along the Y-axis is much less than the contribution of the main rail and the counter rail. For example, the main rail and the counter rail can have 96% influence over the net shape of the linear motion stage and the base plate can have 4% influence over the net shape of the linear motion stage. By having matched main rail and counter rail with similar straightness errors, the straightness errors of the main rail and the counter rail can cancel each other when the main rail and the counter rail are attached back-to-back on the opposite sides of the base plate. Further, it can be easier to build or manufacture the linear motion stage because the straightness errors of base plates that are larger than a threshold can be tolerated. For example, the threshold can be 200 μm, 250 μm, or 300 μm.

In some implementations, referring to the X-ray device 140 in FIGS. 1C and 1D, a neutral axis of the linear motion stage 105 parallel to the Z-axis can be approximately along a plane of symmetry of the base plate as a result of attaching the counter rail to the base plate. For example, the main rail 108 and the counter rail 124 may be made of the same or different materials, and the same or different shapes. But as a result of attaching the counter rail 124 to the base plate 106, the neutral axis of the linear motion stage 105 parallel to the Z-axis can be approximately along a plane of symmetry of the base plate 106. Thus, the straightness error of the linear motion stage 105 can be reduced to be less than a threshold. For example, the threshold can be a value between 25 μm and 300 μm.

In some implementations, the main rail 108 and the counter rail 124 can have the same shape and be made of the same material, and the neutral axis of the linear motion stage can be approximately along the plane of symmetry of the base plate. In some implementations, the main rail 108 and the counter rail 124 can be made of different materials, and the shape for the counter rail 124 can be adjusted based on the shape of the main rail and the different materials such that attachment of the counter rail 124 opposite the main rail 108 on the base plate 106 causes the neutral axis of the linear motion stage to shift toward a plane of symmetry of the base plate 106. For example, as a result of attaching the counter rail to the base plate, the neutral axis of the linear motion stage can be approximately along the plane of symmetry of the base plate. In some implementations, the shape for the counter rail 124 can be rectangular with different height and/or width from the height and/or width of the rectangular shape for the main rail 108.

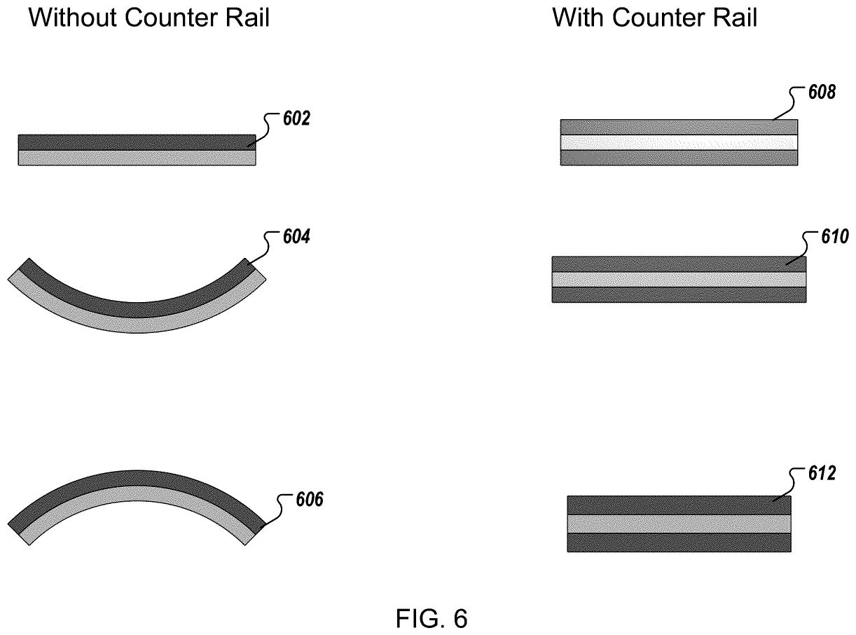

In some X-ray devices, the coefficient of thermal expansion (CTE) for the material of the main rail 108 can be different from the CTE for the material of the base plate 106. Without a counter rail, e.g., such as the X-ray device 110 in FIG. 1B, the different CTEs for the main rail and the base plate can result in straightness errors of the linear motion stage 105 due to changes in temperature. FIG. 6 (left) shows examples of thermal stability of a linear motion stage 602 without a counter rail added to the backside of the base plate from a top-down view. Here, thermal stability means how the shape of the linear motion stage might change under temperature changes. A linear motion stage 602 with a base plate and a main rail can behave like a bi-metallic strip, causing large curvature changes when temperature changes. For example, a linear motion stage of an aluminum base plate and a steel main rail can develop curvature in response to temperature changes, causing or exacerbating straightness errors. The linear motion stage 604 curves upward when it is heated and the linear motion stage 606 curves downward when it cools down. For example, if the base plate in the linear motion stage assembly is already curved in a U-shape, the bimetallic linear motion stage assembly can be curved even more when the temperature increases or decreases.

In some implementations, the straightness error of the linear motion stage under temperature changes can be reduced to be less than a threshold as a result of attaching a counter rail that is matched with the main rail in CTE to the base plate. That is, within a wide range of temperatures, e.g., 0-50 degrees Celsius, the straightness error of the linear motion stage can stay below the threshold. For example, the threshold can be a value between 25 μm and 300 μm. In some implementations, the material of the counter rail can be the same as the material of the main rail and both rails can have the same CTE. In some implementations, the CTE for the material of the counter rail can be the same or similar to CTE for the material of the main rail. In some implementations, the materials for the main rail and the counter rail can have CTEs with a difference that is within a threshold percentage, e.g., less than 20% or 15%, and the counter rail can be required to have a different cross-sectional geometry than the main rail. In some implementations, even though the CTE for the material of the main rail is different from the CTE for the material of the base plate, the straightness error of the linear motion stage under temperature changes can be reduced to be less than the threshold as a result of attaching the counter rail to the base plate.

FIG. 6 (right) shows examples of thermal stability of a linear motion stage 608 with a counter rail added to the backside of the base plate from a top-down view. For example, by adding a steel counter rail to a linear motion stage of an aluminum base plate and a steel main rail, the linear motion stage 610 expands when it is heated and the linear motion stage 612 contracts when it cools down, without curving or bending. Thus, the addition of the counter rail improves the thermal stability of the linear motion stage and develops less curvature in response to temperature changes.

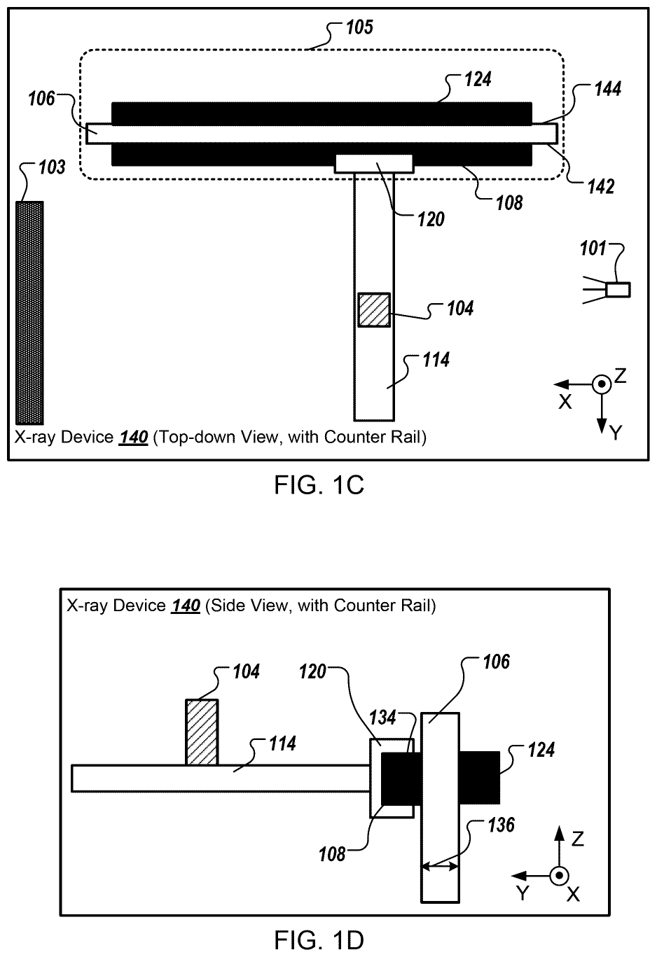

FIG. 2 is a flowchart showing an example of a process 200 to construct a linear motion stage, e.g., the linear motion stage 105 in FIG. 1C. A straightness error for each of two or more rails that have a similar material, and a similar shape is measured (202). For example, several rails from the same manufacturer having the same material and the same shape can be candidate rails.

Based on knowledge that the errors in the straightness profiles of rails mostly arise in the form of a parabolic shape, a single dial-indicator measurement process can be used. The single dial-indicator measurement process can be much simpler than using autocollimators, significantly simplifying the data acquisition process for measuring and pairing the main rails and the counter rails for a linear motion stage assembly for a motion system of an X-ray device. For example, a straightness error can be measured for each of ten rails having the same material and the same shape. Because the errors in the straightness profiles of the rails typically have a parabolic shape or a U-shape, the straightness of the rails can be characterized by a single measurement taken at approximately the center of the rail while both ends of the rail are supported.

FIG. 7A shows an example of a rail straightness measuring device 700. The rail straightness measuring device 700 includes a dial indicator 702 to take the straightness readings. The dial indicator 702 is an instrument used to accurately measure small distances by amplifying the small distances to make the measurement. The device 700 includes one or more dial indicator measuring docks 706 for measurements at one or more locations along a rail. The dial indicator 702 can be placed at one of the dial indicator measuring docks 706 when taking measurements. For example, there are three dial indicator measuring docks 706 in the rail straightness measuring device 700. The dial indicator 702 is placed at the dial indicator measuring dock in the center to take a measurement at approximately the center of a rail. The device 700 includes locating pins 710 that can reliably position the rail to be measured.

In some implementations, before measuring the straightness error for each of the two or more rails that have a similar material, and a similar shape, a calibration for the rail straightness measuring device 700 can be performed. FIG. 7B shows an example of a rail straightness measuring device 700 performing a calibration using a calibration bar 704. A straightness error of a calibration bar 704 can be obtained using a dial indicator 702. The calibration bar 704 has a known and controlled straightness profile and a known self weight deflection. The calibration bar 704 is positioned against the locating pins 710. This calibration process can establish a consistent and reliable datum for subsequent straightness measurements.

After the calibration, a straightness error of each of the two or more rails can be measured using the rail straightness measuring device 700. FIG. 7C shows an example of a rail straightness measuring device performing a straightness measurement of a rail 708. The rail 708 is positioned against the locating pins 710. A straightness measurement of the rail 708 can be taken through the reading of the dial indicator 702. In some implementations, the straightness measurement can be adjusted based on the result of the calibration process. In some implementations, this measurement can be repeated several times and the straightness measurement of the rail 708 can be an average measurement.

A pair of rails from the two or more rails are selected (204) such that an absolute value of a difference between the straightness errors for the pair of rails is less than a threshold. After several rails are measured, the rails can be paired such that an absolute difference between their straightness measurements is less than the threshold, e.g., 50 μm. In some implementations, in order to achieve a desired straightness error for a linear motion stage that is less than a first threshold, the absolute difference between their straightness measurements can be required to be less than two times the first threshold.

For example, the straightness errors of three rails can be 173 μm, 153 μm, and 100 μm. The two rails with the straightness errors of 173 μm and 153 μm can be a pair because the difference between their straightness measurements is 20 μm, which is less than the threshold of 50 μm for the difference between the straightness errors for the pair of rails. As another example, under the threshold of 50 μm for the difference between the straightness errors for the pair of rails, if one rail in a pair of rails has a measurement of 100 μm, the other rail in the pair of rails can have at most a straightness measurement of 150 μm or at minimum a straightness measurement of 50 μm.

A linear motion stage of a motion system of an X-ray device is constructed (206) by attaching a first rail of the pair of rails to one side of a base plate and attaching a second rail of the pair of rails to the opposite side of the base plate. For example, the first rail can be the rail with a straightness error of 153 μm and can be the main rail of the linear motion stage. The second rail can be the rail with a straightness error of 173 μm and can be the counter rail of the linear motion stage. The linear motion stage can be constructed by attaching the main rail to one side of a base plate and attaching the counter rail to the opposite side of the base plate. In some implementations, the main rail and the counter rail can occupy about the same region of the base plate from the two opposite sides of the base plate. In some implementations, the material for the two or more rails can have a larger Young's Modulus than that of a material for a base plate. In some implementations, the thickness of the base plate can be equal to or less than the thickness of the two or more rails.

In some implementations, the counter rail can be attached to the base plate before the main rail is attached to the base plate. In some implementations, the counter rail can be bolted to the base plate using one set of bolts and the main rail can be bolted to the base plate using another set of bolts. In some implementations, the tightening order for the set of bolts for the counter rail can follow the same direction along the X-axis as the tightening order for the set of bolts for the main rail. For example, there can be six bolts spanning the counter rail and six bolts spanning the main rail. The bolts for the counter rail are tightened from the low X end in FIG. 1C, e.g., from the right end of the base plate to the left end of the base plate. The bolts for the counter rail are also tightened following the same direction, from the low X end in FIG. 1C, e.g., from the right end of the base plate to the left end of the base plate.

In some implementations, the rail whose independent neutral axis is further from the linear motion stage assembly's neutral axis can have a greater influence on the overall straightness of the linear motion stage assembly. Thus, the rail whose independent neutral axis is further from the linear motion stage assembly's neutral axis can be the rail with the lower straightness error. A first distance from an independent neutral axis of the first rail to a neutral axis of the linear motion stage if the pair of rails were attached to the opposite sides of the base plate of the linear motion stage can be determined. An independent neutral axis of a part is the neutral axis of the individual part before the part is assembled with another part. A second distance from an independent neutral axis of the second rail to the neutral axis of the linear motion stage can be determined. Whether an absolute difference between the first distance and the second distance is larger than a threshold can be determined. If the absolute difference between the first distance and the second distance is larger than the threshold, one rail from the pair of rails that has less straightness error than the straightness error of the other rail in the pair of rails can be selected. The selected rail can be used as the first rail if the first distance is larger than the second distance, or the selected rail can be used as the second rail if the second distance is larger than the first distance. If the absolute difference between the first distance and the second distance is not larger than the threshold, any rail of the pair of rails can be used as the first rail.

For example, referring to the linear motion stage with the counter rail in FIG. 5 (right drawing), the independent neutral axis of the main rail 506 is the axis 512. The independent neutral axis of the counter rail 510 is the axis 512. The distance from the independent neutral axis 512 of the main rail 506 to the neutral axis 504 of the linear motion stage is the distance d1 (516). The distance from the independent neutral axis 514 of the counter rail 510 to the neutral axis 504 of the linear motion stage is the distance d2 (518). If the absolute difference between d1 and d2 is not larger than a threshold, it does not matter which rail is selected as the main rail versus the counter rail. For example, if the assembly of the main rail, base plate, and the counter rail is exactly symmetric, it does not matter which rail is selected as the main rail versus the counter rail. If the absolute difference between d1 and the d2 is larger than a threshold, e.g., if d2 is larger than 1.5 times d1, the straightness error of the counter rail can have greater influence over the assembly's overall straightness profile than the straightness error of the main rail. The rail with lower straightness error can be selected and used as the counter rail such that the resulting straightness profile of the linear motion stage can have less straightness errors.

In some implementations, referring back to FIG. 2, a target location for an object to be scanned by the X-ray device can be obtained (208). The target location can include a location along the X-axis of the coordinate system in FIG. 1C. The object can be moved (210) to an actual location in the X-ray device by moving a carriage that holds the object along the first rail (main rail) of the linear motion stage, and a distance between the target location and the actual location of the object can be smaller than a distance threshold as a result of attaching the second rail (counter rail) to the base plate. For example, at a cantilever length of 250 mm, the distance threshold can be 100 μm, 200 μm, or 300 μm. For example, as a result of attaching the counter rail that is matched with the main rail in a deviation from straightness, the straightness error of the linear motion stage is reduced to be less than a threshold. Thus, the object can be moved to the actual location that is close to the target location.

In some implementations, after moving the object to the actual location, X-ray scan data of the object can be obtained (212) using the X-ray device. Because the object can be moved to the actual location that is close to the target location, the errors (e.g., scale errors) in the reconstruction image generated from the scan data can be reduced. For example, the source to object distance (SOD) can be approximately the same as the desired SOD corresponding to the target location, resulting in a more accurate magnification factor calculated based on the SOD. Therefore, the CT reconstruction images calculated using the magnification factor can be more accurate.

While this specification contains many implementation details, these should not be construed as limitations on the scope of what is being or may be claimed, but rather as descriptions of features specific to particular embodiments of the disclosed subject matter.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desired results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims.

What is claimed is:

1. An X-ray device comprising:
an X-ray source configured to emit X-rays;
a detector configured to obtain X-ray scan data of an object, wherein the X-ray scan data comprises projections of the X-rays after interaction with the object; and
a motion system comprising
a linear motion stage comprising a main rail attached to one side of a base plate and a counter rail attached to an opposite side of the base plate, wherein the counter rail is matched with the main rail in both a deviation from straightness using a straightness characterization and a coefficient of thermal expansion, and
a carriage attached to the main rail of the linear motion stage, wherein the carriage is arranged to hold the object;
wherein the motion system is configured to move the object in relation to the X-ray source by moving the carriage along the main rail of the linear motion stage.

2. The X-ray device of claim 1, wherein the motion system comprises a cantilever attached to the carriage, and the carriage is arranged to hold the object via the cantilever.

3. The X-ray device of any of claims 1, wherein using the straightness characterization, a straightness error of the linear motion stage is reduced to be less than a first threshold as a result of attaching the counter rail to the base plate.

4. The X-ray device of claim 3, wherein using the straightness characterization, the main rail has a first straightness error before being attached to the base plate, the counter rail has a second straightness error before being attached to the base plate, and an absolute value of a difference between the first straightness error and the second straightness error is less than a second threshold.

5. The X-ray device of any of claims 1, wherein a material for the main rail has a greater stiffness than that of a material for the base plate.

6. The X-ray device of any of claims 1, wherein a first coefficient of thermal expansion for a material of the main rail is different from a second coefficient of thermal expansion for a material of the base plate, and using the straightness characterization, a straightness error of the linear motion stage under temperature changes is reduced to be less than a first threshold as a result of attaching the counter rail to the base plate.

7. The X-ray device of any of claims 1, wherein the main rail and the counter rail are made of a same material and have a same shape.

8. The X-ray device of any of claims 1, wherein the main rail and the counter rail are made of different materials and have different shapes, wherein attachment of the counter rail opposite the main rail on the base plate causes a neutral axis of the linear motion stage to shift toward a plane of symmetry of the base plate.

9. The X-ray device of any of claims 1, wherein the main rail and the counter rail have similar straightness profiles having a parabolic shape.

10. The X-ray device of claim 9, wherein the straightness characterization comprises a single mid-point measurement of rail deviation.

11. A method comprising:
measuring a straightness error for each of two or more rails that have a similar material and a similar shape;
selecting a pair of rails from the two or more rails, wherein an absolute value of a difference between the straightness errors for the pair of rails is less than a threshold; and
constructing a linear motion stage of a motion system of an X-ray device by attaching a first rail of the pair of rails to one side of a base plate and attaching a second rail of the pair of rails to an opposite side of the base plate.

12. The method of claim 11, further comprising:
obtaining a target location for an object to be scanned by the X-ray device;
moving the object to an actual location in the X-ray device by moving a carriage that holds the object along the first rail of the linear motion stage, wherein a distance between the target location and the actual location of the object is smaller than a distance threshold as a result of attaching the second rail to the base plate; and
obtaining X-ray scan data of the object using the X-ray device.

13. The method of any of claims 11, wherein a material for the two or more rails has a larger Young's Modulus than that of a material for the base plate.

14. The method of any of claims 11, wherein a thickness of the base plate is equal to or less than the thickness of the two or more rails.

15. The method of any of claims 11, wherein constructing the linear motion stage comprises:
determining a first distance from an independent neutral axis of the first rail to a neutral axis of the linear motion stage if the pair of rails were attached to opposite sides of the base plate of the linear motion stage;
determining a second distance from an independent neutral axis of the second rail to the neutral axis of the linear motion stage;
determining whether an absolute difference between the first distance and the second distance is larger than a threshold;
in response to determining that the absolute difference between the first distance and the second distance is larger than the threshold, selecting one rail from the pair of rails that has less straightness error than the straightness error of the other rail in the pair of rails; and
using the selected rail as the first rail if the first distance is larger than the second distance, or using the selected rail as the second rail if the second distance is larger than the first distance.

16. A non-transitory computer-readable medium encoding instructions operable to cause data processing apparatus to perform operations comprising:
measuring a straightness error for each of two or more rails that have a similar material and a similar shape;
selecting a pair of rails from the two or more rails, wherein an absolute value of a difference between the straightness errors for the pair of rails is less than a threshold; and
constructing a linear motion stage of a motion system of an X-ray device by attaching a first rail of the pair of rails to one side of a base plate and attaching a second rail of the pair of rails to an opposite side of the base plate.

17. The non-transitory computer-readable medium of claim 16, wherein the operations further comprise:
obtaining a target location for an object to be scanned by the X-ray device;
moving the object to an actual location in the X-ray device by moving a carriage that holds the object along the first rail of the linear motion stage, wherein a distance between the target location and the actual location of the object is smaller than a distance threshold as a result of attaching the second rail to the base plate; and
obtaining X-ray scan data of the object using the X-ray device.

18. The non-transitory computer-readable medium of any of claims 16, wherein a material for the two or more rails has a larger Young's Modulus than that of a material for the base plate.

19. The non-transitory computer-readable medium of any of claims 16, wherein a thickness of the base plate is equal to or less than the thickness of the two or more rails.

20. The non-transitory computer-readable medium of any of claims 16, wherein constructing the linear motion stage comprises:
determining a first distance from an independent neutral axis of the first rail to a neutral axis of the linear motion stage if the pair of rails were attached to opposite sides of the base plate of the linear motion stage;
determining a second distance from an independent neutral axis of the second rail to the neutral axis of the linear motion stage;
determining whether an absolute difference between the first distance and the second distance is larger than a threshold;
in response to determining that the absolute difference between the first distance and the second distance is larger than the threshold, selecting one rail from the pair of rails that has less straightness error than the straightness error of the other rail in the pair of rails; and
using the selected rail as the first rail if the first distance is larger than the second distance, or using the selected rail as the second rail if the second distance is larger than the first distance.
